(19) United States
(12) Patent Application Publication
(10) Pub. No.: US 2015/0370352 A1
(43) Pub. Date: Dec. 24, 2015

(54) ACTIVE STYLUS PEN, DATA INPUT SYSTEM AND CONTROL METHOD OF ACTIVE STYLUS PEN

(71) Applicant: Kabushiki Kaisha Toshiba, Tokyo (JP)

(72) Inventors: Saori Michihata, Sagamihara Kanagawa (JP); Toshiya Takano, Sagamihara Kanagawa (JP); Isao Ohba, Tokyo (JP)

(21) Appl. No.: 14/581,978

(22) Filed: Dec. 23, 2014

(30) Foreign Application Priority Data
Jun. 20, 2014 (JP) 2014-127402

(51) Int. Cl. G06F 3/0354; G06F 3/041

(52) U.S. Cl. CPC G06F 3/03545; G06F 3/0412

(57) ABSTRACT

According to one embodiment, an active stylus pen includes a power supply circuit, an operation detector, a counter and a grip detector. The power supply circuit supplies power from a battery to components in the active stylus pen. The operation detector detects an operation with the active stylus pen being performed for an electronic device capable of receiving the operation. The counter counts an elapsed time after detecting the operation being performed. The grip detector detects the active stylus pen being gripped. The power supply circuit reduces power supply to the components when the elapsed time exceeds a value defined in advance and the active stylus pen being gripped is not detected.

### CROSS-REFERENCE TO RELATED APPLICATIONS

This application is based upon and claims the benefit of priority from Japanese Patent Application No. 2014-127402, filed Jun. 20, 2014, the entire contents of which are incorporated herein by reference.

### FIELD

Embodiments described herein relate generally to an active stylus pen, a data input system and a control method of the active stylus pen.

### BACKGROUND

Recently, an electronic device including an electrostatic capacitive touchpanel called a tablet or phablet has been widespread. In such an electrostatic capacitive touchpanel, it is possible to operate an electronic device with a user's finger since it is possible to detect a small current that is generated when the finger touches a screen, i.e., electrostatic capacitance (electrical quantity), and to detect a position contacted (i.e., touched) by the finger. It is also possible to operate such an electronic device with a pen (stylus pen) for an electrostatic capacitive touchpanel as well as a user's finger.

Note that such an electronic device may have a function to input handwritten characters (handwriting input function) so that a user can perform input operation easily.

A certain amount of contact areas is required to obtain detectable electrostatic capacitance in an electrostatic capacitive touchpanel. Therefore, the tip of a pen for the electrostatic capacitive touchpanel is thicker than that of a conventionally-known digitizer. Accordingly, it is often difficult to write small characters when using the above-mentioned handwriting input function.

On the other hand, there is developed a pen (referred to as an active stylus pen hereinafter) that is equipped with a battery and comprises a mechanism for notifying a touchpanel (sensor) of a position that contacts with the touchpanel by changing the electrostatic capacitance of the contact position. It is possible to write small characters easily by means of such an active stylus pen since it is possible to make the pen tip of the active stylus pen thinner than that of a normal pen.

Therefore, the character input by means of an active stylus pen in an electronic device (for example, tablet) having a character input function has been attracting as a new input interface.

The above-mentioned active stylus pen is driven by power supplied from a battery built in the main body of the pen. A user therefore powers off such an active stylus pen when not using the pen, for example, by a side switch in order to reduce battery consumption (i.e., to save power) in the pen.

However, it is likely that a user forgets to switch on/off the power after using the active stylus pen since the switching needs to be done manually via the side switch. In such a case, it is impossible to reduce battery consumption since the active stylus pen is kept powered on.

Accordingly, it is desired to provide a structure in which battery consumption can be reduced without a user's specific operation when the active stylus pen is not used.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a view illustrating an example of an exterior of an electronic device and an active stylus pen constituting a data input system of an embodiment.

FIG. 2 is a diagram illustrating an example of a system configuration of the electronic device.

FIG. 3 is a schematic view illustrating an example of a structure of the active stylus pen.

FIG. 4 is a cross-sectional view along line IV-IV of the active stylus pen shown in FIG. 3.

FIG. 5 is a diagram illustrating an example of a system configuration of the active stylus pen.

FIG. 6 is a flowchart illustrating an example of a procedure for powering on the active stylus pen.

FIG. 7 is a flowchart illustrating an example of a procedure, for powering off the active stylus pen.

FIG. 8 is a flowchart illustrating an example of a procedure of the electronic device when an operation with the active stylus pen is performed for the electronic device.

### DETAILED DESCRIPTION

Various embodiments will be described hereinafter with reference to the accompanying drawings.

In general, according to one embodiment, an active stylus pen driven by power supplied from a built-in battery is provided. The active stylus pen includes a power supply circuit, an operation detector, a counter and a grip detector. The power supply circuit supplies power from a battery to components in the active stylus pen. The operation detector detects an operation with the active stylus pen being performed for an electronic device capable of receiving the operation. The counter counts an elapsed time after detecting the operation being performed. The grip detector detects the active stylus pen being gripped. The power supply circuit reduces power supply to the components when the elapsed time exceeds a value defined in advance and the active stylus pen being gripped is not detected.

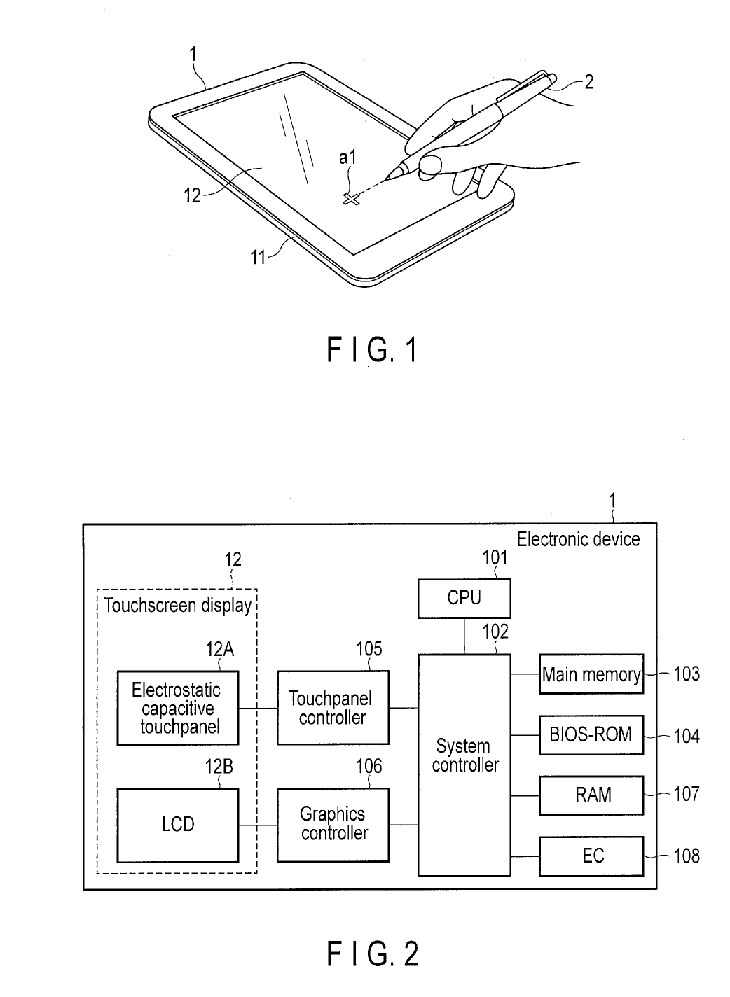

FIG. 1 is a view illustrating an exterior of the electronic device and the active stylus pen constituting the data input system of the embodiment.

In the embodiment, electronic device 1 can be operated by active stylus pen 2 or a user's finger. While electronic device 1 can be realized as a tablet computer, a smartphone, etc., electronic device 1 is realized as a tablet computer in FIG. 1. Note that a tablet computer is a portable electronic device called a tablet or a slate computer.

As shown in FIG. 1, electronic device 1 includes main body 11 and touchscreen display 12. Touchscreen display 12 is attached so as to be overlapped with the upper surface of main body 11.

Main body 11 has a thin box-shaped housing. Touchscreen display 12 is equipped with a flat panel display and a sensor configured to detect the contact position of active stylus pen 2 or a user's finger on the flat panel display. The sensor is an electrostatic capacitive touchpanel and has a function to support active stylus pen 2. The flat panel display includes an LCD. The touchpanel is provided so as to cover the screen of the flat panel display.

Note that electronic device 1 has a function (referred to as a hover function hereinafter) to guide and display mark (hover) al on the position of touchscreen display 12 pointed by the pen tip of active stylus pen 2, which is in a non-contact state with touchscreen display 12, based on a transmission signal output from active stylus pen 2 as described below.

Also, electronic device 1 has a function to input handwriting characters by means of active stylus pen 2.

FIG. 2 is a diagram illustrating a system configuration of electronic device 1. As shown in FIG. 2, electronic device 1 includes CPU 101, system controller 102, main memory 103, BIOS-ROM 104, touchpanel controller 105, graphics controller 106, RAM 107 and EC 108. Also, touchscreen display 12 of electronic device 1 shown in FIG. 1 includes the above-mentioned touchpanel (electrostatic capacitive touchpanel) 12A and LCD 12B.

CPU 101 is a processor configured to control the operation of each component in electronic device 1. CPU 101 loads each type of software from RAM 107 to main memory 103 and executes it. Each type of software has a program for offering the above-mentioned hover function. Also, CPU 101 executes a basic input/output system (BIOS) stored in BIOS-ROM 104. BIOS is a program for controlling hardware.

System controller 102 is a device configured to connect the local bus of CPU 101 and each component. System controller 102 is equipped with a memory controller configured to access and control main memory 103. Also, system controller 102 has a function to execute communication with touchpanel controller 105 and graphics controller 106 via, for example, a serial bus.

Touchpanel controller 105 is a device configured to input the contact position of active stylus pen 2 or a user's finger on touchscreen display 12, which is detected by touchpanel 12A.

Also, touchpanel 12A receives a transmission signal output from active stylus pen 2 and can detect the position of receiving the signal on touchscreen display 12. This position information is input by touchpanel controller 105. Note that the position information input in such a manner is used to, for example, guide and display the above-mentioned hover al or to display a drawing line on LCD 12B. While touchpanel 12A detects a transmission signal when the distance between active stylus pen 2 and touchpanel 12A is, for example, within 20 mm, this distance varies according to the detection accuracy of touchpanel 12A and the transmission intensity of the transmission signal. In the embodiment, while it is assumed that signal transmission is executed only in a unilateral direction from active stylus pen 2 to touchpanel 12A, bilateral communication may be executed between active stylus pen 2 and touchpanel 12A.

Graphics controller 106 is a device configured to control LCD 12B. LCD 12B displays a screen image based on a display signal generated by graphics controller 106. It is thereby possible to display on LCD 12B a drawing line in accordance with the contact position of active stylus pen 2 and a user's finger, which is input by touchpanel controller 105.

EC 108 is a single-chip microcomputer having a controller in charge of power management. EC 108 has a function to power on or off electronic device 1 in accordance with the operation of a power button by a user.

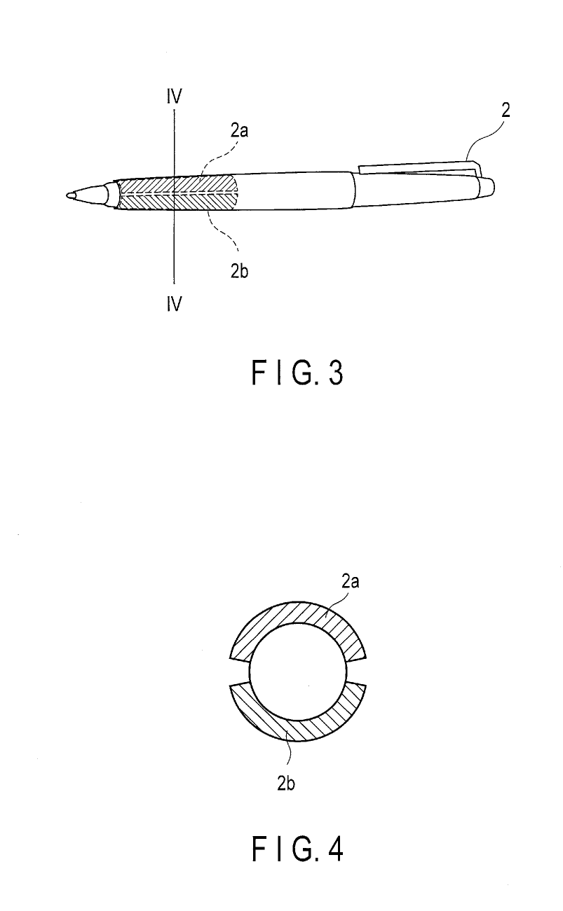

Next, the active stylus pen of the embodiment will be described with reference to FIGS. 3 and 4. FIG. 3 is a schematic view illustrating the structure of active stylus pen 2. FIG. 4 is a cross-sectional view along line IV-IV of active stylus pen 2 shown in FIG. 3.

As shown in FIGS. 3 and 4, a plurality of electrodes (two electrodes 2a and 2b) are arranged along the periphery of a grip portion (handle) in the grip portion of active stylus pen 2. That is, in the embodiment, electrodes 2a and 2b are arranged in a position where a user's finger touches both electrodes 2a and 2b when the user grips active stylus pen 2.

In active stylus pen 2, it is possible to detect active stylus pen 2 being gripped by a user from electrodes 2a and 2b.

Note that active stylus pen 2 is provided with a mechanism for notifying touchpanel 12A of a position that contacts with touchpanel 12A by, for example, changing the electrostatic capacitance of the contact position, which will be described in detail later. Active stylus pen 2 (a mechanism provided therein) is driven by a battery (power supplied therefrom) built in the main body of active stylus pen 2.

Note also that the mechanism provided in active stylus pen 2 includes a mechanism that generates static electricity near the tip of active stylus pen 2 for compensating the change in electrostatic capacitance, which is necessary for touchpanel 12A to detect the contact position, when the pen is driven by a battery.

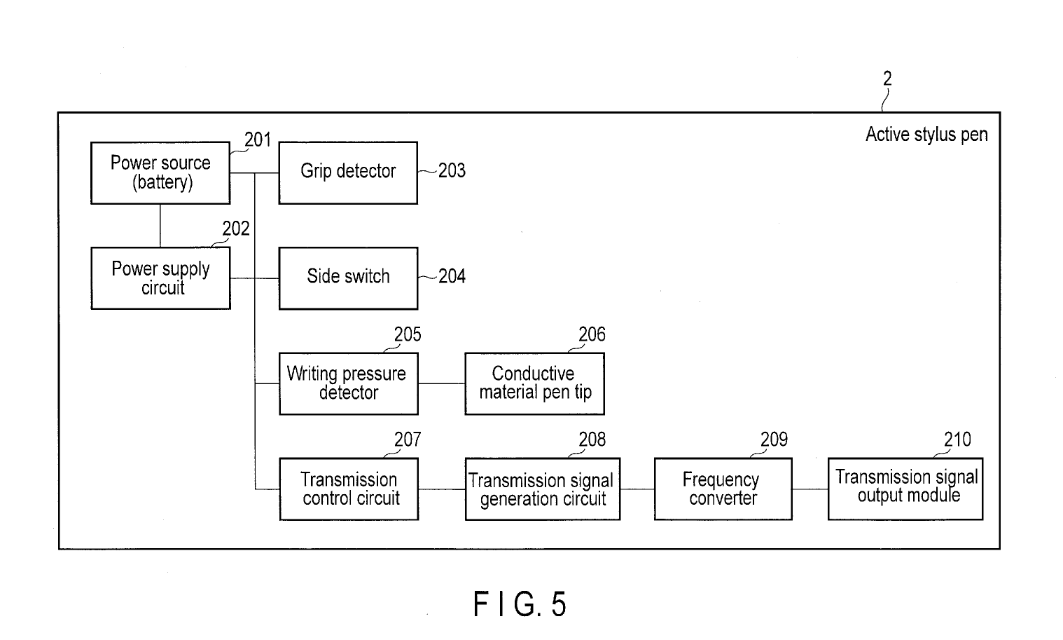

FIG. 5 is a diagram illustrating a system configuration of active stylus pen 2. As shown in FIG. 5, active stylus pen 2 includes power source (battery) 201, power supply circuit 202, grip detector 203, side switch 204, writing pressure detector 205, conductive material pen tip 206, transmission control circuit 207, transmission signal generation circuit 208, frequency converter 209 and transmission signal output module 210.

Power supply circuit 202 is a circuit configured to supply and control power, which is supplied from power source (battery) 201, to each component in active stylus pen 2. Each component in active stylus pen 2 functions when power is supplied from power source (battery) 201 by power supply circuit 202.

Grip detector 203 detects both of the above-mentioned electrodes 2a and 2b being touched by a user (i.e., active stylus pen 2 being gripped by a user).

Side switch 204 is an operation unit having a click function. This click function makes it possible to execute an operation corresponding to a click operation in a mouse, etc. by performing an operation by means of a pen with side switch 204 pressed. Note it is assumed that side switch 204 is a switch operated, for example, by a button that can be pressed with a relatively small force.

Conductive material pen tip 206 is the pen tip of active stylus pen 2 formed of a conductive material.

When an operation (input operation) is performed by means of active stylus pen 2 on touchscreen display 12 and conductive material pen tip 206 contacts (the screen of) touchscreen display 12, writing pressure detector 205 detects the pressure at the time of the input operation.

Transmission control circuit 207 is a circuit configured to control transmission signal generation circuit 208 and generate a transmission signal to electronic device 1.

It is assumed that active stylus pen 2 is powered on. In this case, power supply circuit 202 supplies power to each component (pen circuit) and transmission signal generation circuit 208 generates a transmission signal under control of transmission control circuit 207. A transmission signal generated in transmission signal generation circuit 208 is converted to a signal of a predetermined carrier frequency by frequency converter 209 and is output from transmission signal output module 210 to electronic device 1. Note that this transmission signal is a signal for notifying electronic device 1 of the position of the pen. Also, this transmission signal includes a pen identification number to identify active stylus pen 2, the information of writing pressure detected by writing pressure detector 205, etc. When active stylus pen 2 is brought close to touchscreen display 12 while the pen is thus powered on, it is possible to use the above-mentioned hover function, and hover al shown in FIG. 1 is displayed on touchscreen display 12 in accordance with a transmission signal. It is also possible to display a drawing line on touchscreen display 12 by contacting active stylus pen 2 with touchscreen display 12.

On the other hand, it is assumed that active stylus pen 2 is powered off. In this case, the power supply to each component (pen circuit) by power supply circuit 202 is reduced (disconnected) to stop outputting a transmission signal from active stylus pen 2. Even if active stylus pen 2 is brought close to touchscreen display 12 while the pen is thus powered off, it is not possible to use the above-mentioned hover function, and hover al shown in FIG. 1 is not displayed on touchscreen display 12. Further, even if active stylus pen 2 contacts touchscreen display 12, a drawing line is not displayed on touchscreen display 12.

Note in the embodiment that it is possible to switch on and off active stylus pen 2 without using the above-mentioned side switch 204. In the following, the operation of active stylus pen 2 at the time of switching on and off active stylus pen 2 without using side switch 204 will be described.

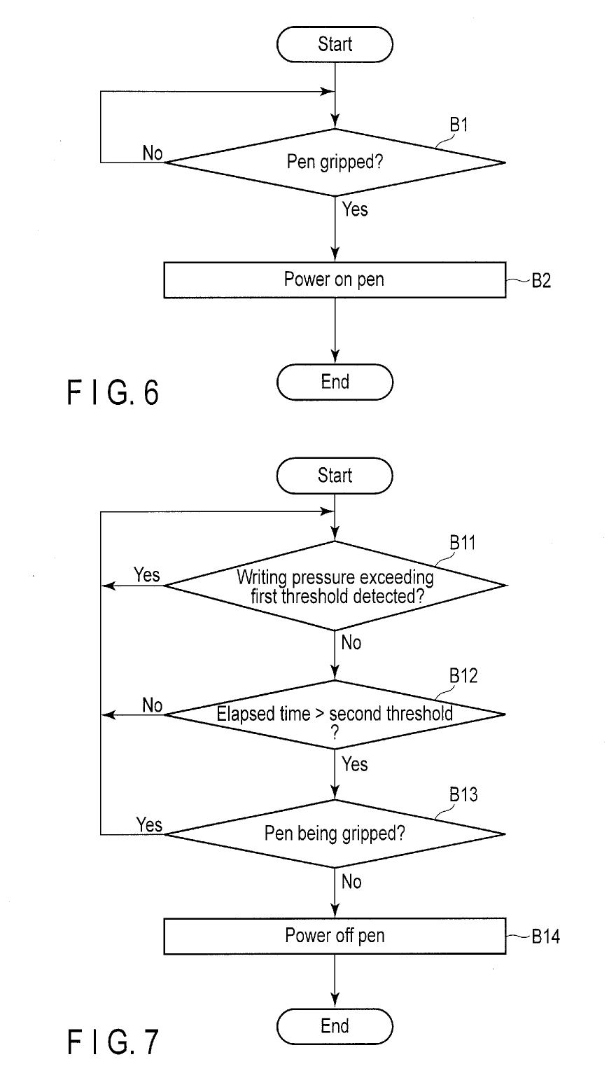

To begin with, a procedure for powering on active stylus pen 2 will be described with reference to FIG. 6.

It is assumed that active stylus pen 2 is powered off. In this case, although the power supply to each component by power supply circuit 202 is reduced (disconnected), power is supplied to, for example, grip detector 203.

When active stylus pen 2 is gripped by a user so as to contact both electrodes 2a and 2b, the pen is electrified by a small current (50-200 μA) that flows to the user. It is thereby possible for grip detector 203 to detect the user's finger touching both electrodes 2a and 2b arranged in the grip part of active stylus pen 2 (i.e., active stylus pen 2 being gripped by the user).

In this case, it is determined in active stylus pen 2 whether the user's finger touching both electrodes 2a and 2b, i.e., active stylus pen 2 being gripped, is detected by grip detector 203 (block B1).

When it is determined that active stylus pen 2 being gripped is not detected (block B1, No), the processing of the above-mentioned block B1 is performed repeatedly until active stylus pen 2 being gripped is detected. In other words, active stylus pen 2 is kept powered off.

On the other hand, when it is determined that active stylus pen 2 being gripped is detected (block B1, Yes), a current flows so that power supply circuit 202 functions by the above-mentioned electrification to power on active stylus pen 2 (block B2). In this case, power supply circuit 202 starts supplying power from power source (battery) 201 to each component constituting electronic device 1 (that is, stop reducing power supply).

Since power is thus supplied from power source (battery) 201 to each component in active stylus pen 2, a transmission signal is output from active stylus pen 2. This allows active stylus pen 2 to operate electronic device 1.

In the embodiment, it is thus possible to power on active stylus pen 2 (supply power to each component constituting active stylus pen 2) when active stylus pen 2 being gripped is detected while active stylus pen 2 is powered off.

Next, a procedure for powering off active stylus pen 2 will be described with reference to the flowchart of FIG. 7.

Note that active stylus pen 2 is powered on by executing the above-mentioned processing shown in FIG. 6, for example.

When a user contacts active stylus pen 2 with touchscreen display 12 for operating electronic device 1, writing pressure detector 205 included in active stylus pen 2 can detect writing pressure in accordance with the contact.

Also, power supply circuit 202 is equipped with a counter in the inside. This counter counts an elapsed time until writing pressure is detected again after writing pressure is detected by writing pressure detector 205.

While active stylus pen 2 is powered on as described above, it is determined in active stylus pen 2 whether writing pressure exceeding a value defined in advance (referred to as the first threshold hereinafter) is detected by writing pressure detector 205 (block B11). In the processing of block B11, it is determined whether active stylus pen 2 contacts touchscreen display 12 included in electronic device 1.

When it is determined that the pressure exceeding the first threshold is not detected (block B11, No), it is then determined whether the elapsed time counted by the above-mentioned counter exceeds a value defined in advance (referred to as the second threshold hereinafter) (block B12).

When it is determined that the elapsed time exceeds the second threshold (block B12, Yes), it is then determined whether active stylus pen 2 being gripped is detected (block B13).

When it is determined that active stylus pen 2 being gripped is not detected (block B13, No), active stylus pen 2 is powered off (block B14). In this case, power supply circuit 202 disconnects power supply from power source (battery) 201 to each component constituting electronic device 1 (that is, reduce power supply).

Since power is thus not supplied from power source (battery) 201 to each component in active stylus pen 2, a transmission signal is not output from active stylus pen 2. It is therefore impossible to operate electronic device 1 by active stylus pen 2.

On the other hand, when it is determined that the writing pressure exceeding the first threshold is detected (block B11, Yes), when it is determined that the elapsed time does not exceed the second threshold (block B12, No), or when it is determined that active stylus pen 2 being gripped is detected (block B13, Yes), the processing is repeated by returning to the above-mentioned block B11. That is, as it is assumed in these cases that a user uses active stylus pen 2, active stylus pen 2 is kept powered on.

Note as to active stylus pen 2 that if the transmission interval of a transmission signal is defined as the first interval when it is determined that the writing pressure exceeding the first threshold is detected, if the transmission interval of a transmission signal is defined as the second interval when it is determined that the elapsed time does not exceed the second threshold although the writing pressure exceeding the first threshold is not detected, and if the transmission interval of a transmission signal is defined as the third interval when it is determined that the writing pressure exceeding the first threshold is not detected and that the elapsed time exceeds the second threshold, it is possible to define: first interval<second interval<third interval; first interval<second interval=third interval; or first interval=second interval<third interval.

In the embodiment, it is thus possible to power off active stylus pen 2 (disconnect power supply to each component constituting active stylus pen 2), when a certain amount of writing pressure is not detected (i.e., active stylus pen 2 does not touch touchscreen display 12), when the elapsed time after the last writing pressure exceeds the second threshold and when active stylus pen 2 being gripped is not detected, while active stylus pen 2 is powered on.

Note while it has been explained that power supply circuit 202 is equipped with a counter, the processing of block B12 may be omitted when power supply circuit 202 is not equipped with a counter. In this case, when a certain amount of writing pressure is not detected and when active stylus pen 2 being gripped is not detected, active stylus pen 2 is powered off.

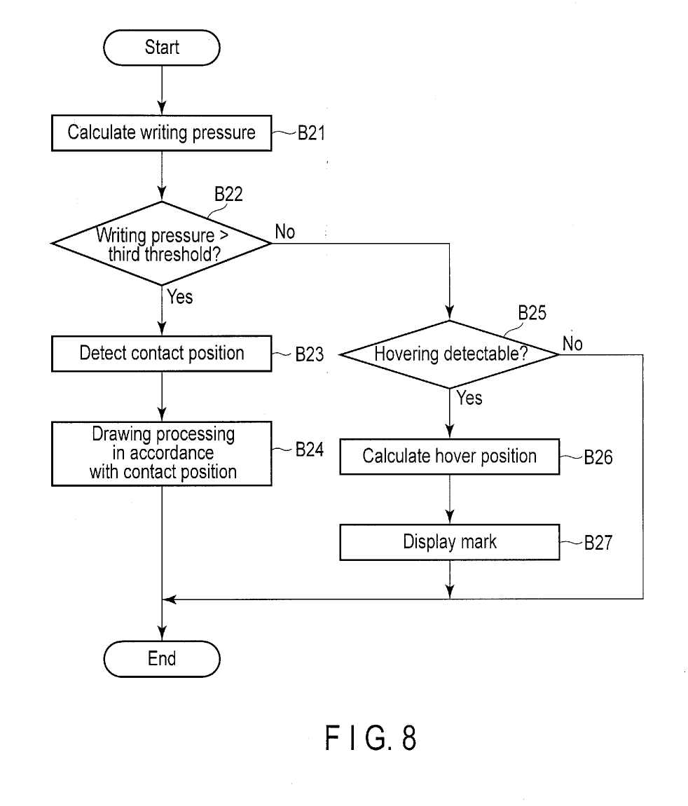

Next, a procedure of electronic device 1 when an operation with active stylus pen 2 is performed for electronic device 1 will be described with reference to the flowchart of FIG. 8.

When a user brings active stylus pen 2, which is powered on for operating electronic device 1, close to touchscreen display 12, touchpanel 12A included in electronic device 1 can receive a transmission signal output from active stylus pen 2. That is, when active stylus pen 2 is positioned within a certain distance from touchscreen display 12, electronic device 1 can detect active stylus pen 2.

When active stylus pen 2 positioned within the certain distance is detected in electronic device 1 and a transmission signal is received by touchpanel 12A, electronic device 1 calculates the writing pressure of active stylus pen 2 for touchscreen display 12 based on the information of the writing pressure included in the transmission signal (block B21).

Next, it is determined in electronic device 1 whether the calculated writing pressure exceeds a value defined in advance (referred to as the third threshold hereinafter) (block B22). Note that it is determined in the processing S22 whether active stylus pen 2 contacts touchscreen display 12 included in electronic device 1.

When it is determined that writing pressure exceeds the third threshold (block B22, Yes), touchpanel 12A detects the position of receiving the above-mentioned transmission signal output from active stylus pen 2 on touchscreen display 12 (i.e., the contact position of active stylus pen 2) (block B23).

In this case, graphics controller 106 executes drawing processing in accordance with a contact position detected by touchpanel 12A (block B24). Thereby, the graphics controller 106 displays on LCD 12B a drawing line in accordance with a contact position.

On the other hand, when it is determined that writing pressure does not exceed the third threshold (block B22, No), touchpanel 12A determines whether hovering can be detected based on a received transmission signal (block B25). In this case, if active stylus pen 2 is positioned within a certain distance from touchscreen display 12, the position of active stylus pen 2 can be defined and it is determined that hovering can be detected. Note that a certain distance with which to define the position of active stylus pen 2 is shorter than the above-mentioned certain distance with which to detect active stylus pen 2.

When it is determined that hovering can be detected (block B25, Yes), a hover position is calculated based on the position of receiving a transmission signal by touchpanel 12A (block B26).

In this case, graphics controller 106 displays a mark (for example, mark al shown in FIG. 1) on the hover position calculated in such a manner (block B27). It is thereby possible for a user to use the hover function in a state where active stylus pen 2 does not contact touchscreen display 12.

On the other hand, when it is determined that hovering cannot be detected (block B25, No), the processing of block B26 and B27 are not executed and the processing of electronic device 1 is ended.

As described above, in the embodiment, when the elapsed time after detecting an operation being performed by active stylus pen 2 (i.e., writing pressure exceeding a value defined in advance) exceeds a value defined in advance and when active stylus pen 2 being gripped (i.e., a user's finger contacting both electrodes 2a and 2b) is not detected, power supply to each component constituting active stylus pen 2 is reduced (i.e., active stylus pen 2 is powered off). In the embodiment, such a structure makes it possible to reduce consumption of power source (battery) 201 and to save power, since it is possible to automatically power off active stylus pen 2 when it can be assumed that active stylus pen 2 is not used, even if a user forgets to power off by operating side switch 204, for example.

Also, in the embodiment, the reduction of power supply to each component constituting active stylus pen 2 is stopped (i.e., active stylus pen 2 is powered on) when active stylus pen 2 being gripped is detected while the power supply to each component is reduced (i.e., active stylus pen 2 is powered off). In the embodiment, such a structure makes it possible to improve a user's convenience since the user can power on active stylus pen 2 by a normal operation at the time of using active stylus pen 2, without performing any special operation such as an operation for side switch 204.

Note in the embodiment that while it has been explained that active stylus pen 2 is mainly powered on and off, active stylus pen 2 can also be operated in a sleep mode (power save mode), for example. In such a case, the above-mentioned processing shown in FIG. 6 may be executed when, for example, a sleep mode (mode in which an operation by active stylus pen 2 cannot be performed) returns to a normal mode (mode in which an operation by active stylus pen 2 can be performed). In this case, the processing where the sleep mode of active stylus pen 2 transitions to the normal mode may be executed in block B2 shown in FIG. 6. Similarly, it is also possible to execute the above-mentioned processing shown in FIG. 7 when, for example, the normal mode transitions to the sleep mode. In this case, the processing where the sleep mode of active stylus pen 2 transitions to the normal mode may be executed in block B14 shown in FIG. 7.

Also, while it has been explained that active stylus pen 2 is powered on when active stylus pen 2 being gripped is detected, it is also possible that a predetermined application program is booted in electronic device 1 when a transmission signal is output from active stylus pen 2 after active stylus pen 2 is powered on. That is, it may be possible to make electronic device 1 perform a predetermined operation as well as power on active stylus pen 2 by detecting active stylus pen 2 being gripped.

Further, while it has been explained that active stylus pen 2 includes two electrodes 2a and 2b in the embodiment, active stylus pen 2 may include three or more electrodes. When active stylus pen 2 thus includes three or more electrodes, it is possible to power on active stylus pen 2 only when how active stylus pen 2 is gripped is detected at the time of operating electronic device 1, since it is possible to determine how active stylus pen 2 is gripped.

Furthermore, while it has been explained that power is supplied to grip detector 203 to detect active stylus pen 2 being gripped even when active stylus pen 2 is powered off in the embodiment, active stylus pen 2 may include an alternative mechanism for disconnecting power supply to grip detector 203 (for example, a switch for switching on/off a main power) for a case, for example, where active stylus pen 2 is not used for a long time. This switch has a structure in which the main power is not switched on/off easily even when, for example, the switch is in a bag. Specifically, it is not a switch operated with a button that can be pressed with a relatively small force, but a switch (hard switch) in which the power can be switched on/off by, for example, sliding.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An active stylus pen driven by power supplied from a built-in battery, comprising:
a power supply circuit to supply power from the battery to components in the active stylus pen;
an operation detector to detect an operation with the active stylus pen being performed for an electronic device capable of receiving the operation;
a counter to count an elapsed time after detecting the operation being performed; and
a grip detector to detect the active stylus pen being gripped, wherein
the power supply circuit reduces power supply to the components when the elapsed time exceeds a value defined in advance and the active stylus pen being gripped is not detected.

2. The active stylus pen of claim 1, wherein the grip detector comprises a plurality of electrodes arranged in a position where a user's finger contacts the plurality of electrodes while the user grips the active stylus pen, and detects the active stylus pen being gripped when the user's finger contacts the plurality of electrodes.

3. The active stylus pen of claim 1, wherein the operation detector comprises a writing pressure detector to detect writing pressure of the active stylus pen for the electronic device and detects the operation being performed when writing pressure exceeding a value defined in advance is detected by the writing pressure detector.

4. The active stylus pen of claim 1, wherein the power supply circuit stops reducing power supply to the components when the active stylus pen being gripped is detected while power supply to the components is reduced.

5. A data input system comprising an active stylus pen driven by power supplied from a built-in battery and an electronic device capable of receiving an operation with the active stylus pen, wherein the active stylus pen comprises:
a power supply circuit to supply power from the battery to components in the active stylus pen;
an operation detector to detect an operation with the active stylus pen being performed for the electronic device;
a counter to count an elapsed time after detecting the operation being performed; and
a grip detector to detect the active stylus pen being gripped, wherein
the power supply circuit reduces power supply to the components when the elapsed time exceeds a value defined in advance and the active stylus pen being gripped is not detected.

6. A control method of an active stylus pen driven by power supplied from a built-in battery, comprising:
supplying power from the battery to components in the active stylus pen;
detecting an operation with the active stylus pen being performed for an electronic device capable of receiving the operation;
counting an elapsed time after detecting the operation being performed;
detecting the active stylus pen being gripped; and
reducing power supply to the components when the elapsed time exceeds a value defined in advance and the active stylus pen being gripped is not detected.
